(19) United States
(12) Patent Application Publication
(10) Pub. No.: US 2010/0161425 A1
(43) Pub. Date: Jun. 24, 2010

(54) SYSTEM AND METHOD FOR TARGETED DELIVERY OF AVAILABLE SLOTS IN A DELIVERY NETWORK

(76) Inventor: Gil Sideman, Tenafly, NJ (US)

Correspondence Address: Pearl Cohen Zedek Latzer, LLP, 1500 Broadway, 12th Floor, New York, NY, 10036, US

(21) Appl. No.: 12/376,828

(22) PCT Filed: Aug. 10, 2007
(86) PCT No.: PCT/US07/17798

§ 371 Date: Feb. 9, 2009

Related U.S. Application Data
(60) Provisional application No. 60/836,655, filed on Aug. 10, 2006.

(51) Int. Cl. G06Q 30/00

(52) U.S. Cl. 705/14.66

(57) ABSTRACT

A system and method is provided for outputting a media stream including advertisements to a user at a user terminal, where advertisements are requested at a user terminal from a server and may be selected based on user parameters corresponding to the user.

### BACKGROUND

Distribution of certain goods or commodities such as advertisements is imperfect and inefficient. Centralized or consolidated distribution of goods, for example, by a network of servers, may strain the capacity of a delivery network and inefficiently deliver goods directed to individual users.

### SUMMARY

A system and method is provided for outputting a media stream including advertisements to a user at a user terminal, where advertisements may be requested at a user terminal from a server and may be selected based on user or usage parameters corresponding to the user.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of a delivery network, including one or more servers for providing streaming media and advertisements, one or more computers or terminals for users to view the advertisements in available slots in the streaming media and one or more client side agents for inserting the advertisements into the available slots, according to one embodiment of the present invention;

FIG. 2 is a schematic illustration of a web page with a graphical user interface allowing media users to select a set of user parameters, and its interaction with other components, according to one embodiment of the present invention;

FIG. 3 is a schematic illustration of a graphical user interface to expose media users to targeted advertisements integrated into streaming media and its interaction with other components, according to one embodiment of the present invention; and

FIG. 4 is a flowchart of a method according to an embodiment of the present invention.

It will be appreciated that for simplicity and clarity of illustration, elements shown in the figures have not necessarily been drawn to scale. For example, the dimensions of some of the elements May be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

The processes presented herein are not inherently related to any particular computer, server, terminal or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, as apparent from the following discussions, throughout the specification discussions utilizing terms such as “processing,” “computing,” “calculating,” “determining,” or the like, refer to the action and/or processes of a computer or workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention may allow for efficient and targeted distribution of advertisements or other media, via for example a delivery network or advertisement delivery system, to users watching or listening to media streams at user terminals or computers. Other embodiments of the present invention relate to delivering or inserting goods in available slots in a delivery network targeted at individual users, allowing client side agents to deliver or insert goods in available slots allocated for the goods (e.g. by server side system components) in a delivery network that may be accessed, viewed or listened to by users based on user parameters corresponding to the users. A slot may be, for example, a specific space within a broadcast in which an advertisement is placed. Compared with server side advertisement insertion, client side advertisement insertion may be a more efficient means of delivering goods in available slots in a delivery network targeted at individual users.

A user, such as a listener, may use a client side process possibly including a client side agent to listen to or view a media stream, such as a radio program. Based on user parameters, such as demographic parameters, and usage parameters, such as when and to what a user listens, a client side agent may have advertisements distributed to it and may insert the advertisements into available slots within advertisement pods in the media stream.

In one embodiment, available slots in a delivery network may be sold, auctioned or allocated to customers or advertisement providers. For example, advertisements may be auctioned to be delivered during advertisement slots or pods, for example, in streaming media directed or targeted at specific users described by parameters selected by advertisement providers. Advertisement providers may select parameters that describe a group or subset of slots targeted at a group or subset of users. In one embodiment, advertisement providers may compete in a series of auctions to be allocated one or more available slots during a broadcast. In other embodiments, available slots in a delivery network may be sold at a fixed price, for example, determined according to market standards. Other methods and systems of delivering advertisements, or of deciding which advertisements to allocate to users, may be used.

A delivery network may include a server side and a client side. The server side of the delivery network may include components (e.g., a host server or a media server) that may send or output goods (e.g., advertisements) and streaming media to a user at user side components (e.g., a user computer or terminal). The client side of the delivery network may include components that may request or receive (e.g., client agents operating on a user's computer or terminal), store (e.g., in a memory area at a user's terminal such as a client side agents' cache or other memory area), deliver or insert goods into available slots in a delivery network (e.g., client side agents) or display (e.g., a graphical user interface (GUI) or a display at a user terminal) goods or streaming media (e.g., from server side components) to users. While a media stream is being broadcast to a user (e.g., via a media GUI) a client side agent may insert or integrate the appropriate advertisements (e.g., which may be retrieved from storage) into available advertisement slots or pods in the streaming media.

For example, an online radio delivery network or advertisement delivery system may include an online radio broadcast server that may provide streaming radio, an advertisement server or host server that may output advertisements to individual targeted users at user terminals, a radio broadcast player at the user terminal with one or more integrated client side agents that accepts advertisements from the host server and inserts advertisements targeted at a user in available slots allocated in the streaming radio, where the radio broadcast player displays, delivers, outputs or plays the advertisements to the user. The advertisement server may be part of the radio broadcast server.

Users viewing or listening to programming may disclose user information, such as personal, demographic or other information, for example, by selecting a set of user parameters. Goods may be directed at, delivered to or inserted into streaming media accessed by users, for example, by the client side agent, based on the user parameters and usage parameters. Advertisements may be targeted, outputted or delivered to users who fit specific target user information, for example, selected by a customer or advertisement provider. Such users may be exposed to streaming media based on user parameters corresponding to the user, for example, via a media GUI, including advertisement spots.

### General System

In one embodiment, goods or commodities such as advertisements may be delivered, output or inserted into available slots in a delivery network, for example, by an agent on the client side of a delivery network. A client side agent may provide a user accessing or viewing streaming media, for example, from a media server, goods targeted at the user, for example, from a host server, via a media GUI. The streaming media may include advertisement pods. An advertisement pod may be for example a space within a media stream or broadcast during which an advertisement may be played. The client side agent may request appropriate advertisements from the host server, which may be stored locally, for example, in a cache unit, at the user terminal or local computer, where they may be easily accessed. Advertisements may be stored separately from the media stream at the user terminal. The client side agent may be informed (e.g., receive a signal) if an advertisement pod or space reserved for advertisements appears in a media stream accessed by the user and may access the appropriate advertisements (e.g., from the cache unit or other memory) and deliver, insert, integrate or embed the advertisements into the appropriate advertisement slots or pods. A user may view the advertisements, which may be integrated with streaming media, for example, using a display such as a media GUI.

In other embodiments, any suitable entities, goods or commodities may be delivered, for example, advertisements, rights to telephone networks, wireless or wired communication networks, etc. which may be for example integrated into a pre-existing network on the client side of a delivery network. Delivery networks may include, for example, terrestrial or online television or radio networks, telephone networks, digital or wireless devices and computer systems and networks. Available slots in a delivery network may be, for example, added to or integrated into, and utilized in, display contexts, such as streaming media, wireless and Internet-based devices, interactive TV, web sites and other applications.

In one embodiment of the present invention, an advertisement delivery system for streaming media is presented, where the available slots constitute potential advertising time segments or pods. A method or system may allow a user to access a media stream and view advertisements inserted into the available slots, where the advertisements are targeted at the user. The targeted advertisements may be delivered or inserted into the media stream based on user parameters corresponding to the user. Users may select a set of parameters describing personal, demographic or other information. Advertisements may correspond to or be associated with a subset of user parameters that may include users' selected parameters and possibly additional information, for example, user usage information. Advertisements that correspond to a subset of user parameters that substantially match the set of user parameters may be delivered to users, for example, in available slots in an appropriate media stream.

In one embodiment, the advertisement delivery system may sell or auction available advertisement slots in radio programs or other audio (or video) that may be delivered or distributed to targeted users in a delivery network, e.g., using a network such as the Internet and via an online radio player.

### System Overview

According to some embodiments of the present invention, goods or commodities may be delivered by a delivery network that may include server side and client side components. Server side components may include one or more servers, for example, a host server and a media server, which may reside at the same site or be the same server, or which may be physically separate. The host server or advertisement server may generate client side interfaces, sell, auction or otherwise allocate advertisement slots, and deliver or output targeted advertisements to client side components of the delivery network. In one embodiment, the host server may deliver individual advertisements to targeted users. Advertisements may be delivered and inserted into slots independently of the order in which they may be delivered to the user, for example, randomly or according to when a slot is allocated from the advertisements. In other embodiments, the host server may deliver groups of advertisements to users, for example, an ordered advertisement sequence (e.g., ordered by sale price). An advertisement sequence may include all advertisements that may be delivered to a target user by a delivery network in available advertisement slots of the delivery network (e.g., in order of delivery). For example, if the delivery network delivers a media stream to a user at a terminal, the advertisement sequence may include all advertisements that may be delivered to a target user during the duration of the broadcast of the media stream. The media server may deliver, output or transmit streaming media to client side components of the delivery network such as a client side agent, for example, at the client side agent's request. The advertisements may be inserted (e.g., by the client side agent) into the streaming media in the order with which they appear in the advertisement sequence. The integrated broadcast may be viewed by targeted users when they access the appropriate media streams.

In one embodiment, the advertisement provider may select to which users the advertisement may be accessible or potentially delivered to, for example, by selecting a set of user parameters that correspond to targeted users. In one embodiment, advertisements targeted towards one or more users may be customized for the individually targeted users, for example, by the advertisement provider. For example, the advertisement provider may control the content and design of the advertisement. In one embodiment, the advertisement provider may use tools to create or upload an advertisement. The advertisement provider may, for example, select the type(s) of streaming media with which the customer advertisement may be broadcast (e.g., internet radio, internet television, terrestrial media, etc.) advertisement format (e.g., only text, streaming banner, audio and/or visual with optional text, images or image streams, text-to speech or animated figure technology, etc., one or more music tracks and/or one or more jingle/sound effect tracks with variable play time, volume, etc.). The advertisement provider may use a terminal, computer or device to upload or access advertisements or advertisement tools from a host database or from another suitable source, for example, a computer memory, an additional server and/or external device, such as, a music storage device. Advertisements may vary in length, content and format.

### System Details

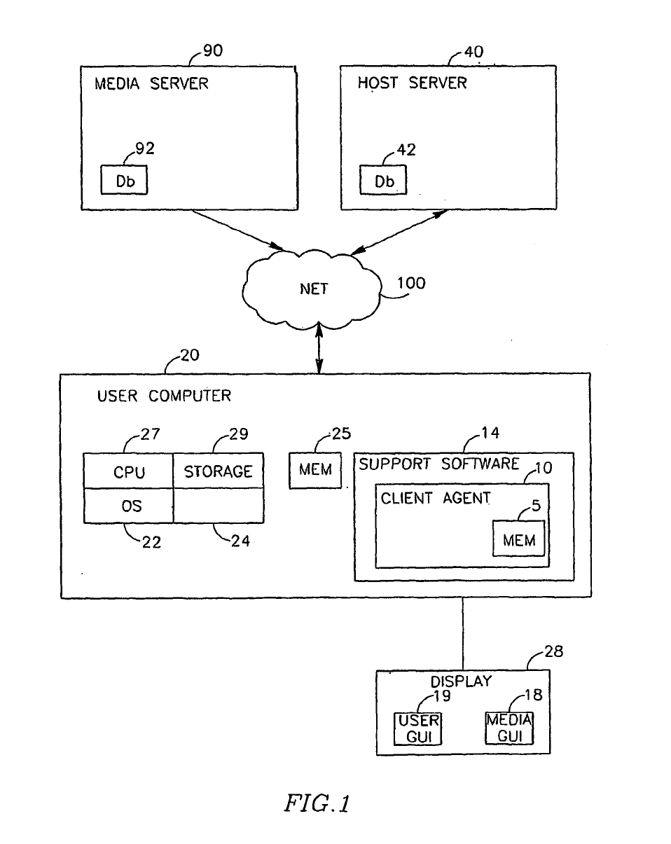

FIG. 1 schematically illustrates a delivery network, including one or more servers for providing streaming media and advertisements, one or more computers or terminals for users to view the advertisements in available slots in the streaming media and one or more client side agents for inserting the advertisements into the available slots, according to one embodiment of the present invention. An online advertisement delivery system 1 may include a host server 40 that may deliver targeted advertisements to client side components of the delivery network such as client side agents 10, for example, through one or more communications networks such as Internet 100.

Host server 40 may include interactive (e.g., two-way) connections, for example, via Internet 100, with users, via one or more local user terminals 20, media sources, via one or more media servers 90 and any other suitable systems or components. Server side components of the delivery network may include host server 40 and media server 90, which may include databases 42 and 92, respectively. In one embodiment, host server 40 may access media server 90. In other embodiments, client processes on user terminals may directly access each of host server 40 and media server 90 separately. Media server 90 may, for example, provide streaming media such as a selection of radio or video programs to users at user terminals 20. Servers, computers or systems may access host server 40 and media server 90 directly or indirectly, via networks such as Internet 100 using wireless or hardwired connections.

Host server 40 or another server may generate or support user interfaces, for example, a user GUI 19, that may, for example, accept disclosed user information such as demographic or personal information. Host server 40 may have two-way connections such that host server 40 may read input and write output, for example, from and to local user terminal 20 via user GUI 19, using Internet 100. In one embodiment, host server 40 may include dynamic components to execute dynamic functions, for example, generating advertisement sequences, allocating, selling or auctioning available slots in a delivery network, accepting user and advertisement provider parameters, etc., and separate static components to store data, for example, the advertisement sequences generated by the dynamic components, user parameters corresponding to users, etc.

User terminal 20 may be accessed or used by a user, for example, locally. User terminal 20 may include a memory 25, a processor 27, a monitor or output device 28, a mass storage device 29, an operating system 22, support software 24 and client support software 14 and may operate a media GUI 18 and a user GUI 19. Media GUI 18 may, for example be a radio or video player allowing a user to play media streams such as streaming radio. For example, media GUI 18 may be similar to the RealPlayer™ media player, but other applications may be used. Support software 24 may include, for example, Internet support software for displaying user GUI 19, for example, via a web page. Client support software 14 may include, for example, media support to display media GUI 18, media agents to display streaming media to targeted users on media GUI 18 and one or more client side agents 10 to integrate and display specific advertisements into the streaming media. Agents separate from media GUI 18 need not be used. Media support software and/or client side agents 10 may be software embedded or integrated into support software 14. Different client side agents 10 may support different advertising formats, for example, different client side agents 10 may support text or written advertisements, streaming banners, audio and/or visual advertisements or some combination of these. Different advertising formats may be displayed separately or substantially simultaneously, for example, in different display windows on media GUI 18. Monitor or output device 28 may display media GUI 18 and optional user GUI 19. User terminal 20 may include other components and capabilities.

### User GUIs

Users viewing or listening to programming may disclose user information, such as personal, demographic or other information, for example, by selecting a set of user parameters. Goods such as advertisements may be directed at, delivered to or inserted into streaming media accessed by users, for example, by client side agent 10, based on the user parameters corresponding to the user. Advertisements may be directed or delivered to users who fit, specific target user information, for example, selected by a customer or advertisement provider. Such users may be exposed to streaming media based on user parameters corresponding to the user, for example, via media GUI 18.

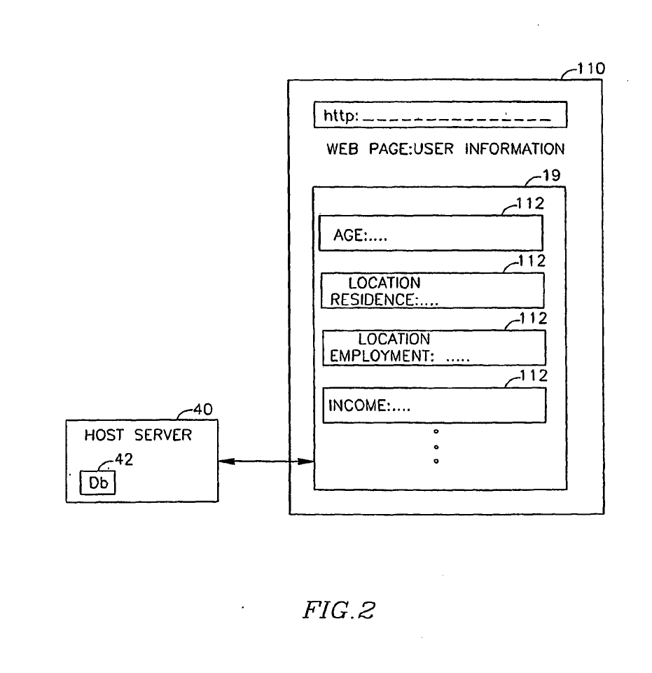

FIG. 2 schematically illustrates a web page with a graphical user interface allowing media users to input or select a set of user parameters; and its interaction with other components, according to one embodiment of the present invention. In one embodiment, user information fields 112 may be displayed on one or more user GUI 19 screens that may be viewed on one or more of web pages 110. Advertisement delivery system 1 may provide user GUI 19 using server side components including host server 40 and client side components including support software 14. Support software 24 may support web pages using for example Hyper Text Markup Language (HTML), C++ or other languages.

In one embodiment, users may disclose user information that may be accepted, recorded, stored or used, for example, by host server 40. A user may, for example, select, at user terminal 20 a set of user parameters (e.g., the set of user parameters may correspond to the user) by entering information into user information fields 112 provided by user GUI 19. User information fields 112 may include, for example, demographics, location of residence and/or employment, zip or postal code, age, income level or any other suitable user information. A derivation of such data may be stored for storage or privacy reasons. User usage information may also include additional user information fields, which may or may not be explicitly disclosed or selected by the user, such as, radio stations selected, and times and/or days or dates of use, the time a user is operating a streaming media GUI 18, the type of streaming media requested, the user's most frequently viewed or listened to programs or the times of day the user listens to or views programs. Undisclosed additional user information fields may be recorded, for example, using cookies, as is known in the art.

For each user that discloses information or uses media GUI 18, user parameters corresponding to the user may be stored, for example, on server side components such as host server 40 and/or client side components such as client side agent 10. In one embodiment, user parameters corresponding to the user may include a derivation of information entered into user information fields 112 and/or usage information, for example, a grouping or categorization of users. For example, if a user selects age: 17, parameters, corresponding to the user may be stored as age range: 15-20. In one embodiment, users with substantially matching corresponding user parameters that view substantially similar media streams may be delivered substantially similar advertisements based on the user parameters corresponding to the users.

In one embodiment, a user may be required to enter user information into some or all user information fields 112 in order to gain rights to view streaming media. In different embodiments, a user may be required to enter user information once or substantially every time the user requests access to the streaming media.

Advertisements may be selected, delivered, inserted into an appropriate media stream or outputted based on user parameters corresponding to the user at the user terminal or at another location, for example a remote server such as host server 40. In one embodiment, advertisements that correspond to a set of user parameters that substantially match information a user enters into user information fields 112 and additional usage information fields may be delivered to the user. Such advertisements may be ordered in an advertisement sequence so that substantially each advertisement in the advertisement sequence may correspond to a set of user parameters describing the user and the user's usage information (e.g., when the user listens, and to what). The advertisements may be inserted into available slots in a delivery network and, delivered to users according to embodiments of the invention who disclose information that falls within the target user range.

In one embodiment, a media stream and a set of advertisements, separately received by a media player, may be combined at a user terminal into one output stream. For example, a media GUI may receive a media stream, such as a radio broadcast, from one server, and may receive a set of advertisements from another server. The media GUI may at the user terminal combine the advertisements and the media stream by, for example, inserting the advertisements into the media stream, overlaying the advertisements, or via another method.

In one embodiment, for each broadcast and each group of users (e.g., users who have substantially similar user information), a substantially unique advertisement sequence may be created comprising all advertisements that correspond to parameters that match the users' information and to which available slots in a delivery network were allocated.

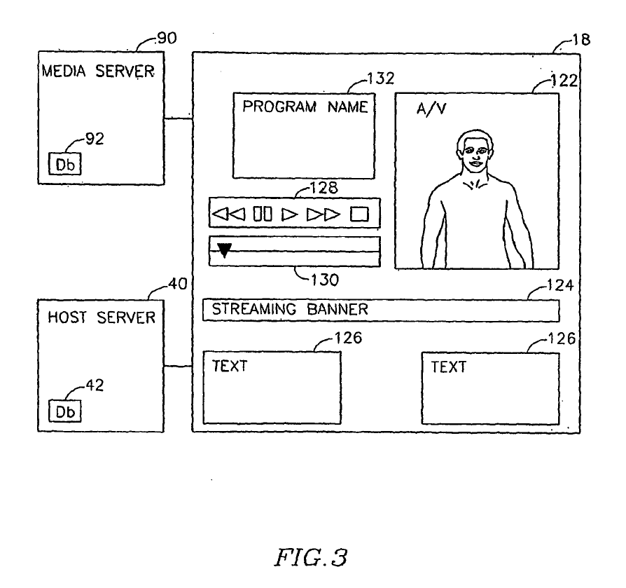

FIG. 3 is a schematic illustration of a graphical user interface allowing media users to view targeted advertisements integrated into streaming media and its interaction with other components, according to one embodiment of the present invention. In one embodiment, users may view, hear or otherwise be exposed to advertisements integrated into streaming media, via media GUI 18. Media GUI 18 may include, for example, a radio or television player to play radio or television programs. Other media GUIs and other types of streaming media may be used.

In one embodiment, advertisements with different formats may be displayed on media GUI 18 in different advertisement windows. For example, advertisement windows may include an audio and/or visual window 122, a streaming banner window 124, a text window 126, or any other suitable windows. In one embodiment, advertisements with different formats may be supported by different client side agents 10, for example, a first, a second and a third distinct client side agent 10 may support text advertisements, streaming banners and audio and/or visual advertisements, respectively. In some embodiments, if no advertisement of the appropriate format was sold or allocated, generic advertisements or advertisements already in a media stream may be displayed or output or no advertisements may be displayed or output and corresponding windows 122, 124 and/or 126 may be hidden on media GUI 18. In some embodiments, advertisement windows 122, 124 and/or 126 are only displayed when an advertisement is being delivered.

In some embodiments, media GUI 18 may include an information window 132 that displays or indicates information pertaining to the media stream currently being broadcast, for example, the program name, radio of television station, genre, broadcast time period, etc. In some embodiments, the user may view the temporal progress of the streaming broadcast via timeline 130, for example, a time bar, which may indicate, for example, the segment in time that is currently being displayed in relation to the total length of the broadcast. The user may control the progress of a broadcast, for example, by using controls 128. Controls 128 may include, for example, play, pause stop, forward, rewind, etc. In some embodiments, a viewer may not use or have access to some or all of controls 128 during an advertisement pod.

Advertisement delivery system 1 may provide media GUI 18 using server side components including media server 90 and host server 40 and client side components including client side support software 14 and client side agents 10. In one embodiment, media GUI 18 may receive input of streaming media and corresponding advertisements from media server 90 and host server 40, respectively.

Media server 90 may provide a specific broadcast or media stream to a user via media GUI 18, for example, at the user's request (e.g., the user using media GUI 18 at the station and time of broadcast). Streaming media may be displayed or delivered to the user on media GUI 18 using a client side or server side media agent.

Host server 40 may provide targeted advertisements, which correspond to the specific media stream, to client side components of the delivery network, for example, if the user requests the media stream. Advertisements targeted to an individual user may be delivered to the client side agents 10 on the user's local terminal 20. In one embodiment, client side agent 10 may request advertisements at a user terminal from host server 40 based on user parameters corresponding to the user. Client support software 14 may support, for example, Flash or other animated vector graphics applications or software. In other embodiments, advertisements need not be targeted.

In one embodiment, client side agent 10 may accept and store the advertisements targeted at a user provided by host server 40, for example, at the user's terminal 20. Advertisements may be stored separately from the media stream into which they may be inserted. In other embodiments, the advertisements need not be stored locally at the user terminal 20. For example, the advertisements may be stored in host server 40 and delivered to client side agent 10 individually or in groups of advertisements allocated for an advertisement pod.

In one embodiment; client side agent 10 may insert one or more advertisements into appropriate advertisement slots or pods of the media stream by overlaying media onto the media stream, muting or not outputting the ongoing media stream, or pausing, interrupting, overlaying, bypassing or delaying the media stream and inserting the appropriate advertisements into the slots, for example, just prior to when the advertisements are delivered to the user. Client side agent 10 may insert a targeted advertisement to a targeted user, if the advertisement is provided, for example, by host server 40. For example, during an advertising pod or slot, a media stream output may be suppressed or muted, but may continue to be streamed, and advertisements may be overlaid or played instead.

A broadcast or media stream output by a media GUI 18 may include a fixed number of advertisement pods that may be of fixed length and may include a number of available slots in which advertisements may be inserted. For example, a broadcast may have a three minute advertisement pod every twelve minutes. The number of available slots or advertisement pods during a broadcast may be different for each broadcast.

In one embodiment, a broadcast or media stream may include indicators that may indicate that an advertisement pod is accessed or viewed by a user or that an advertisement may be inserted into the media stream. For example, a digital media stream may include a signal, inserted in the audio portion or inserted in a non-audio portion accompanying the audio portion, for example as a mode. When such an indication or signal is detected (e.g., in the media stream) or received (e.g., by client side agent 10), the appropriate advertisements may be retrieved (e.g., by client side agent 10) from storage (e.g., from a cache unit on the user's local terminal 20) and inserted or combined or integrated into the advertisement pod. In response to a signal in the media stream, client side agent 10 may insert or replace a portion of the media stream with an advertisement. The signal or indicator may also indicate the position in the media stream where the advertisement is inserted. The media stream may be output as a seamless integration of the media stream and advertisements.

When a gap or advertisement pod appears in a media stream, client side agent 10 may access a set of advertisements from an ordered sequence from storage, for example, from cache or other memory 5 or 25. Advertisements may be inserted, for example, according to their ordering in the ordered sequence. For example, the first advertisement pod in the media stream may be filled with a first set of advertisements in the advertisement sequence, the next advertisement pod may be filled with a next set of advertisements and so on. In such a manner, the first advertisement in the sequence is more likely to be exposed to a user (e.g., who may only listen for a certain amount of time) then the second, and so on. For each media stream, broadcast to each user, the advertisement sequence may include advertisements, corresponding to parameters that substantially match the user's usage information, for all available slots in the media stream allocated, sold or otherwise reserved. In other embodiments, other methods of distributing and allocating advertisements, not using a sequence, may be used.

In another embodiment, each advertisement in an advertisement sequence may be inserted into fixed slots in a media stream. Thus, if the user tunes in for a middle portion of the broadcast, the user may view advertisements in a middle portion of the advertisement sequence. In another embodiment, an advertisement sequence or a portion of the sequence may be integrated into a streaming media broadcast, starting when the user tunes into a broadcast or accesses the media stream. Thus, if the user tunes in for a middle portion of the broadcast, the user may view a beginning portion of the advertisement sequence. An advertisement that is first in the advertisement sequence may thus be allocated the first advertisement slot that a user views, regardless of when the user tunes in.

In one embodiment, host server 40 may provide client side agent 10 with a surplus of advertisements for a media stream broadcast, where there are more advertisements than there are available slots in the media stream. In some embodiments, an advertisement sequence for a media broadcast may include repeated advertisements or groups of advertisements, for example, a repeating loop. Client side agent 10 may insert advertisement into available slots in the media stream until there are no more slots available in the media stream. After some or all of the advertisements for a media stream broadcast have been inserted into the media stream, after the last advertisement pod or after the broadcast, the advertisement sequence for the broadcast may be replaced, deleted or updated from storage. For example, the advertisement sequence for the old broadcast may be replaced or overwritten in storage on user terminal 20, for example, by the advertisement sequence for the next broadcast on the same radio or television channel.

In one embodiment, host server 40 or media server 90 may provide default or generic advertisements that may be delivered in available slots to users (e.g., not targeted) if the slots are not allocated, sold or otherwise reserved. For example, a radio stream may have advertisements inserted in the original radio broadcast, which in some cases are not replaced by the client side agent 10. In one embodiment, such generic advertisements may be provided by media server 90, for example, integrated into media streams. In such embodiments, client side agent 10 may only interrupt or overlay a media stream to insert or replace advertisements in available slots if client side agent 10 receives from host server 40 targeted advertisements for those available slots. For example, if a slot in a delivery network is allocated to an advertisement provider, the default or pre-existing advertisements for the slot in the media stream are silenced and the advertisement of the advertisement provider to which the slot is allocated is played instead. In some embodiments, separate client side agent 10 need not be used. For example, media GUI 18 may request and insert advertisements. In other embodiments, host server 40 may provide all advertisements, for example, either generic or targeted. For each available slot in a media stream, host server 40 may send client side agent 10 an advertisement, which may be targeted or generic and client side agent 10 may insert the advertisements according to embodiments of the invention. In some embodiment, advertisements with certain formats (e.g., text or streaming banners) may be delivered to a user without interrupting the streaming media.

Advertisement providers may be charged for advertisements successfully delivered to target users. For each user, client side agent 10 may keep a metered tally of such deliveries to the user. Host server 40 may record incidences of such deliveries and charge advertisement providers accordingly. For example, if a user signs off early or signs on late within a time block and only certain advertisements are delivered to the user, typically only those advertisement providers whose advertisements are delivered to the user are charged.

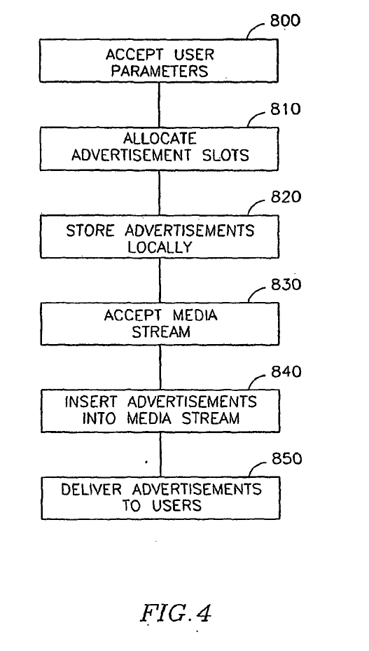

FIG. 4 is a flowchart of a method according to one embodiment of the present invention.

In operation 800, a host server may accept user information. Users may correspond to user information or parameters that may be recorded, stored or used, for example, by the host server. User information may include, for example, a set of user parameters selected or entered by users, for example, by entering information into user information fields provided by a user GUI. The set of user parameters may include, for example, demographics, location of residence and/or employment, zip or postal code, age, income level and any other suitable user information. Usage information may be used or recorded by a host server, that is not explicitly disclosed or selected by the user, such as, radio stations viewed, times of viewing, times a user operates a media GUI, types of streaming media requested, user's most frequently viewed or listened to programs or times of day the user listens to or views programs.

In operation 810 the host server may allocate advertisements slots in a delivery network. The advertisements generated may be unique to a user. For example, the server may generate an advertisement sequence. In one embodiment, for each broadcast or media stream and each group of users (e.g., users who have substantially similar user information), the host server may generate a substantially unique advertisement sequence comprising all advertisements that correspond to parameters that match the users information and to which available slots in a delivery network are allocated. In one embodiment, the advertisement sequence may be ordered (e.g., by sale price).

In operation 820, a client side process, such as a client side media player or a client side agent may receive and store advertisements locally. In one embodiment, the host server may send client side agents, for example, in a user's local terminal, advertisements, for example, advertisement sequences for all accessible broadcasts, generated for the user in operation 810. The client side agents may store the advertisement sequences locally in a cache or other memory area at the user's local terminal, where they may be easily retrieved. In other embodiments, the advertisements need not be stored locally at the user terminal. For example, the advertisements may be stored in the host server and delivered to client side agent individually or in groups of advertisements allocated for individually advertisement pods.

In operation 830, a media GUI may accept a media stream, for example, from the media server.

In operation 840, the client side agent may insert advertisements into a media stream. In one embodiment, a media stream and a set of advertisements, separately received by a media player, may be combined at a user terminal into one output stream. If a user accesses or views the media stream and a space or advertisement pod appears in the media stream, (e.g., indicated by a marker or signal in the media stream received by the client side agent) the client side agent may retrieve a subset of the advertisements from the ordered sequence, generated for the media stream, from storage. The subset of advertisements may be overlaid or inserted, for example, according to their ordering in the ordered sequence. The next advertisement pod in the media stream may be filled with a next set of advertisements in the advertisement sequence and so on. For each media stream broadcast to each user, the advertisement sequence may include advertisements, corresponding to parameters that substantially match the user's usage information, for all available slots in the media stream allocated, sold or otherwise reserved. Only a portion of a sequence, for example, enough to fill an advertisement pod, may be inserted at one time; alternately the entire sequence may be inserted.

The client side agent may insert the advertisements into an advertisement pod of the appropriate media stream by for example overlaying, muting, pausing, interrupting, bypassing Advertisements may be inserted, for example, just prior to when they are delivered to the user.

In operation 850, a media GUI may deliver advertisements to users. In one embodiment, only advertisements that are targeted to users may be displayed on the media GUI on the user's local terminal. In other embodiments, if slots accessed by the user in a delivery network have not been allocated, said or otherwise reserved, the media GUI may display generic advertisements to the user.

In one embodiment, users may view, hear or otherwise be exposed to advertisements targeted to them, for example, displayed on the media GUI, that may be delivered, for example, integrated into streaming media, by the client side components of a delivery network.

The media GUI may include, for example, a radio or television player, a cellular phone or other digital, wired or wireless devices to play radio or television programs.

In one embodiment, the host server may charge advertisement providers whose advertisements were delivered to target users. The client side agent and/or host server may keep a metered tally of such deliveries.

Other operations or series of operations may be used.

It will be appreciated by persons skilled in the art that the present invention is not limited to what has been particularly shown and described hereinabove. Rather the scope of the present invention is defined only by the claims, which follow:

1. A method comprising:
outputting a media stream to a user at a user terminal; and
at the user terminal, accepting advertisements from a server based on user parameters corresponding to the user.

2. The method of claim 1 comprising storing the advertisements separately from the media stream at the user terminal.

3. The method of claim 1 comprising detecting in the media stream a signal indicating that an advertisement may be inserted into the media stream.

4. The method of claim 1 comprising inserting the advertisements into the media stream.

5. The method of claim 4, wherein the advertisements are inserted in an advertisement pod.

6. The method of claim 4, wherein the advertisements are to replace default advertisements within the media stream.

7. The method of claim 4 comprising overlaying the media stream.

8. The method of claim 1 comprising, in response to a signal in the media stream, replacing a portion of the media stream with an advertisement.

9. The method of claim 1 comprising:
receiving an ordered sequence of advertisements; and
inserting the advertisements into the media stream according to the order of the advertisements in the sequence.

10. The method of claim 1 comprising accepting from the user at the user terminal a subset of the set of user parameters corresponding to the user.

11. The method of claim 1 comprising accepting advertisements from a server based on usage parameters corresponding to the user.

12-25. (canceled)

26. A system comprising:
a user terminal comprising a media player to accept a media stream from a server and to output the media stream; and
a client side agent to request advertisements from a server, wherein the advertisements are selected based on user parameters corresponding to a user.

27. The system of claim 26 comprising a media server providing the media stream.

28. The system of claim 26 comprising an advertisement server providing the advertisements.

29. The system of claim 26, wherein the user terminal comprises a graphical user interface to accept a set of user parameters selected by the user.

30. The system of claim 26, wherein the user terminal comprises a graphical user interface outputting the advertisements.

31. The system of claim 26, wherein the client side agent is to insert the advertisements in the media stream.

32. The system of claim 29, wherein the advertisements are inserted in an advertisement pod.

33. The system of claim 29, wherein the advertisements replace default advertisements within the media stream.

34-46. (canceled)

47. A device comprising:
a memory to store advertisements; and
a processor to output a media stream to a user, and to accept advertisements from a server based on user parameters corresponding to a user.

48. The device of claim 47 wherein the advertisements are stored separately from the media stream at the device.

49. The device of claim 47 wherein the processor is to detect in the media stream a signal indicating that an advertisement may be inserted into the media stream.

50. The device of claim 47 wherein the processor is to insert the advertisements into the media stream.

51. The device of claim 50 wherein the advertisements are inserted in an advertisement pod.

52. The device of claim 50 wherein the advertisements are to replace default advertisements within the media stream.

53. The device of claim 50 wherein the processor is to overlay the media stream.

54. The device of claim 47 wherein the processor is to, in response to a signal in the media stream, replace a portion of the media stream with an advertisement.

55. The device of claim 47 wherein the processor is to:
receive an ordered sequence of advertisements; and
insert the advertisements into the media stream according to the order of the advertisements in the sequence.

56. The device of claim 47 wherein the processor is to accept from the user at the user terminal a subset of the set of user parameters corresponding to the user.

57. The device of claim 47 wherein the processor is to accept advertisements from a server based on usage parameters corresponding to the user.

58. A method comprising:
at a media player being executed on a user terminal, accepting a media stream from a server and outputting the media stream; and
at a client side agent being executed on the user terminal, requesting advertisements from a server, wherein the advertisements are selected based on user parameters corresponding to a user.

59. The method of claim 58 wherein a media server provides the media stream and wherein an advertisement server provides the advertisements.

60. The method of claim 58, comprising the user terminal accepting via a graphical user interface a set of user parameters selected by the user.

61. The method of claim 58 comprising the user terminal outputting the advertisements via a graphical user interface.

62. The method of claim 58 comprising inserting the advertisements in the media stream.

63. The method of claim 58, wherein the advertisements are inserted in an advertisement pod.

64. The method of claim 58, wherein the advertisements replace default advertisements within the media stream.
